(19) United States
(12) Patent Application Publication
(10) Pub. No.: US 2013/0320914 A1
(43) Pub. Date: Dec. 5, 2013

(54) BATTERY BALANCE APPARATUSES

(71) Applicant: Chengdu Monolithic Power Systems Co., Ltd., Chengdu (CN)

(72) Inventor: Zhen Li, Hangzhou (CN)

(21) Appl. No.: 13/908,886

(22) Filed: Jun. 3, 2013

(30) Foreign Application Priority Data
Jun. 4, 2012 (CN) 201210179402.3

(51) Int. Cl. H02J 7/00

(52) U.S. Cl. CPC H02J 7/0014
USPC 320/103

(57) ABSTRACT

A battery balance apparatus with a battery pack of N battery cells, an inductor, a first rectifying switch, a second rectifying switch, a third rectifying switch, a fourth rectifying switch and N+1 controllable switches.

### CROSS-REFERENCE TO RELATED APPLICATION(S)

This application claims priority to and the benefit of Chinese Patent Application No. 201210179402.3, filed on Jun. 4, 2012, which is incorporated herein by reference in its entirety.

### TECHNICAL FIELD

The present invention relates generally to electronic apparatuses, and more particularly but not exclusively to battery balance apparatuses.

### BACKGROUND

In recent years, more and more electronic products use battery packs comprising serial-connected battery cells as their power source. In a battery pack, cell imbalance may occur due to the differences in the characteristics of the battery cells, such as the charge and discharge state, cell capacity, temperature characteristic, etc. This imbalance will shorten the battery life and reduce the capacity of the entire battery pack. So, battery balance apparatuses are needed to ensure security and stability.

A battery apparatus with balance function was disclosed in a Chinese Patent Application (Publication No.: CN102111003A) titled “New Battery Balance Circuit and Control Method Thereof”, which was published on Jun. 29, 2011. Compared with conventional technologies, apparatuses disclosed in the application could improve the efficiency of energy transfer. However, the apparatuses disclosed therein are too complex and would increase the cost.

### SUMMARY

Embodiments of the present invention are directed to a battery balance apparatus, comprising: a battery pack having an anode and a cathode, wherein the battery pack comprise N serial-connected battery cells, N is an integer larger than one, and wherein each of the battery cells has an anode and a cathode, and wherein the anode of the battery pack is coupled to the anode of the first serial-connected battery cell, and the cathode of the battery pack is coupled to the cathode of the Nth serial-connected battery cell; an inductor having a first terminal and a second terminal; a first rectifying switch coupled between the anode of the battery pack and the first terminal of the inductor; a second rectifying switch coupled between the cathode of the battery pack and the first terminal of the inductor; a third rectifying switch coupled between the anode of the battery pack and the second terminal of the inductor; a fourth rectifying switch coupled between the cathode of the battery pack and the second terminal of the inductor; and N+1 controllable switches, wherein the first controlled switch is coupled between the anode of the first battery cell and the second terminal of the inductor, the second controlled switch is coupled between the anode of the second battery cell and the first terminal of the inductor, and the third controlled switch is coupled between the cathode of the second battery cell and the second terminal of the inductor.

Furthermore, there has been provided, in accordance with an embodiment of the present invention, a battery balance apparatus, comprising: a battery pack having an anode and a cathode, wherein the battery pack comprise N serial-connected battery cells, and each of the battery cells has an anode and a cathode, and wherein the anode of the battery pack is coupled to the anode of the first serial-connected battery cell, and the cathode of the battery pack is coupled to the cathode of the Nth serial-connected battery cell; an inductor having a first terminal and a second terminal; a first rectifying switch coupled between the anode of a power supply and the first terminal of the inductor; a second rectifying switch coupled between the cathode of the power supply and the first terminal of the inductor; a third rectifying switch coupled between the anode of the power supply and the second terminal of the inductor; a fourth rectifying switch coupled between the cathode of the power supply and the second terminal of the inductor; and N+1 controllable switches wherein the first controlled switch is coupled between the anode of the first battery cell and the second terminal of the inductor, the second controlled switch is coupled between the anode of the second battery cell and the first terminal of the inductor, and the third controlled switch is coupled between the cathode of the second battery cell and the second terminal of the inductor.

There has been provided, in accordance with another embodiment of the present invention, a stack balance apparatus, comprising: a balance apparatus pack having an anode and a cathode, wherein the balance apparatus pack comprise M serial-connected battery balance apparatuses, M is an integer larger than one, and wherein each of the battery balance apparatuses has an anode and a cathode, and wherein the anode of the stack battery pack is coupled to the anode of the first serial-connected balance apparatuses, and the cathode of the battery pack is coupled to the cathode of the Nth serial-connected balance apparatuses; a stack inductor having a first terminal and a second terminal; a first rectifying stack switch coupled between the anode of the balance apparatus pack and the first terminal of the stack inductor; a second rectifying stack switch coupled between the cathode of the balance apparatus pack and the first terminal of the stack inductor; a third rectifying stack switch coupled between the anode of the balance apparatus pack and the second terminal of the stack inductor; a fourth rectifying stack switch coupled between the cathode of the balance apparatus pack and the second terminal of the stack inductor; and M+1 controllable stack switches wherein the first controlled switch is coupled between the anode of the first balance apparatuses and the second terminal of the stack inductor, the second controlled switch is coupled between the anode of the second balance apparatuses and the first terminal of the stack inductor, and the third controlled switch is coupled between the cathode of the second balance apparatuses and the second terminal of the stack inductor.

### BRIEF DESCRIPTION OF THE DRAWINGS

Non-limiting and non-exhaustive embodiments are described with reference to the following drawings. The drawings are only for illustration purpose. Usually, the drawings only show part of the devices of the embodiments. These drawings are not necessarily drawn to scale. The relative sizes of elements illustrated by the drawings may differ from the relative size depicted.

FIG. 1 shows a battery balance apparatus 100 in accordance with an embodiment of the present invention.

FIG. 2 shows a battery balance apparatus 200 in accordance with an embodiment of the present invention.

FIG. 3A-3C show battery packs in accordance with different embodiments of the present invention.

FIG. 4 shows a battery balance apparatus 400 in accordance with an embodiment of the present invention.

FIG. 5A and FIG. 5B show the operation of the balance apparatus 100 when energy is transferred from the battery cell C1 to the battery pack.

FIG. 5C and FIG. 5D show the operation of the balance apparatus 100 when energy is transferred from the battery cell C2 to the battery pack.

FIG. 6 shows a battery balance apparatus 600 in accordance with an embodiment of the present invention.

FIG. 7A and FIG. 7B show the operation of the balance apparatus 100 when energy is transferred from the battery pack to the battery cell C1.

FIG. 7C and FIG. 7D show the operation of the balance apparatus 100 when energy is transferred from the battery pack to the battery cell C2.

FIG. 8A and FIG. 8B show the operation of the balance apparatus 100 when energy is transferred from an over voltage battery cell to an under voltage battery cell

FIG. 9 shows a battery balance apparatus 900 in accordance with an embodiment of the present invention.

FIG. 10A and FIG. 10B show the operation of the balance apparatus 900 when energy is transferred from the power supply to an under voltage battery cell.

FIG. 11A-11C shows battery balance apparatus 1100, 1101 and 1102 in accordance with embodiments of the present invention.

FIG. 12 shows a stack balance apparatus 1200 in accordance with an embodiment of the present invention.

FIG. 13 shows a stack balance apparatus 1300 in accordance with an embodiment of the present invention.

### DETAILED DESCRIPTION

In the present invention, numerous specific details are provided, such as examples of circuits, components, and methods, to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

It is to be understood in these letters patent that the meaning of “A” is coupled to “B” is that either A and B are connected to each other as described below, or that, although A and B may not be connected to each other as described below, there is nevertheless a device or circuit that is connected to both A and B. This device or circuit may include active or passive circuit elements, where the passive circuit elements may be distributed or lumped-parameter in nature. For example, A may be connected to a circuit element that in turn is connected to B.

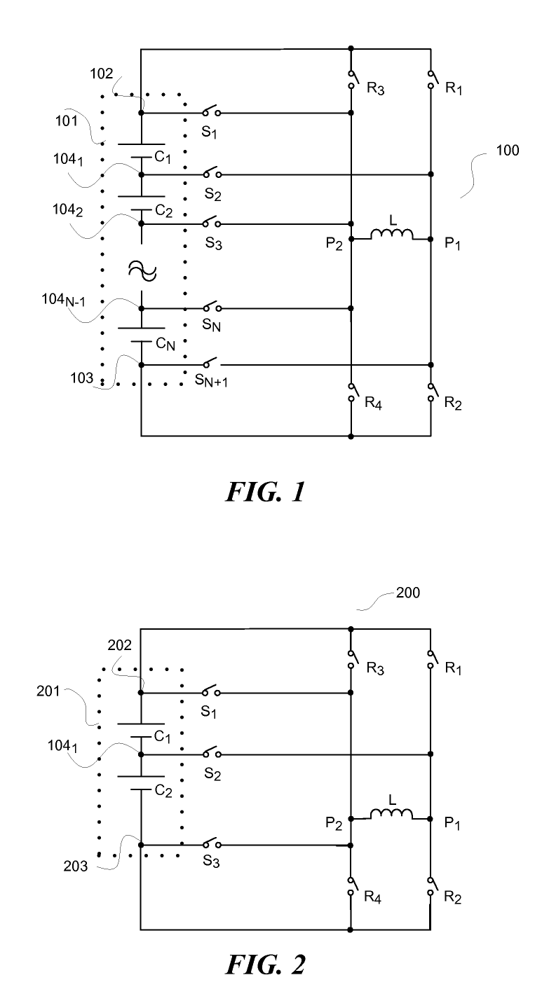

FIG. 1 schematically shows a battery balance apparatus 100 according to an embodiment of the present invention. The battery balance apparatus 100 comprises a battery pack 101, rectifying switches R₁˜R₄, an inductor L and controllable switches S₁˜S_{N+1}. The battery pack 101 comprises serial-connected battery cells C₁˜C_{N}. The battery pack 101 also has an anode 102, a cathode 103, and a plurality of common connection terminals 104₁˜104_{N-1} formed by the adjacent battery cells. The inductor L has two terminals, a first terminal P₁ and a second terminal P₂. The first rectifying switch R₁ is coupled between the anode 102 of the battery pack 101 and the first terminal P₁ of the inductor L. The second rectifying switch R₂ is coupled between the cathode 103 of the battery pack 101 and the first terminal P₁ of the inductor L. The third rectifying switch R₃ is coupled between the anode 102 of the battery pack 101 and the second terminal P₂ of the inductor L. The fourth rectifying switch R₄ is coupled between the cathode 103 of the battery pack 101 and the second terminal P₂ of the inductor L. The controllable switches S₁˜S_{N+1} are configured to respectively couple the anode and the cathode of each of the battery cells to the two terminals of the inductor L. The controllable switch S₁ is coupled to the anode 102 of the battery pack 101. The controllable switches S₂˜S_{N} are coupled to the common connection terminals 104₁˜104_{N-1} of the battery pack 101. The controllable switch S_{N+1} is coupled to the cathode 103 of the battery pack 101.

Each battery cell has an anode and a cathode. In the embodiment shown in FIG. 1, the anode of the battery cell C₁ is also the anode 102 of the battery pack 101, the cathode of the battery cell C_{N} is also the cathode 103 of the battery pack 101. The anode and the cathode of each of the battery cells are respectively coupled to the two terminals of the inductor L through the controllable switches. For example, the anode and cathode of the battery cell C₁ are respectively coupled to the second terminal P₂ and the first terminal P₁ of the inductor L through the controllable switches S₁ and S₂; the anode and the cathode of the battery cell C₂ are respectively coupled to the first terminal P₁ and the second terminal P₂ of the inductor L through the controllable switches S₂ and S₃.

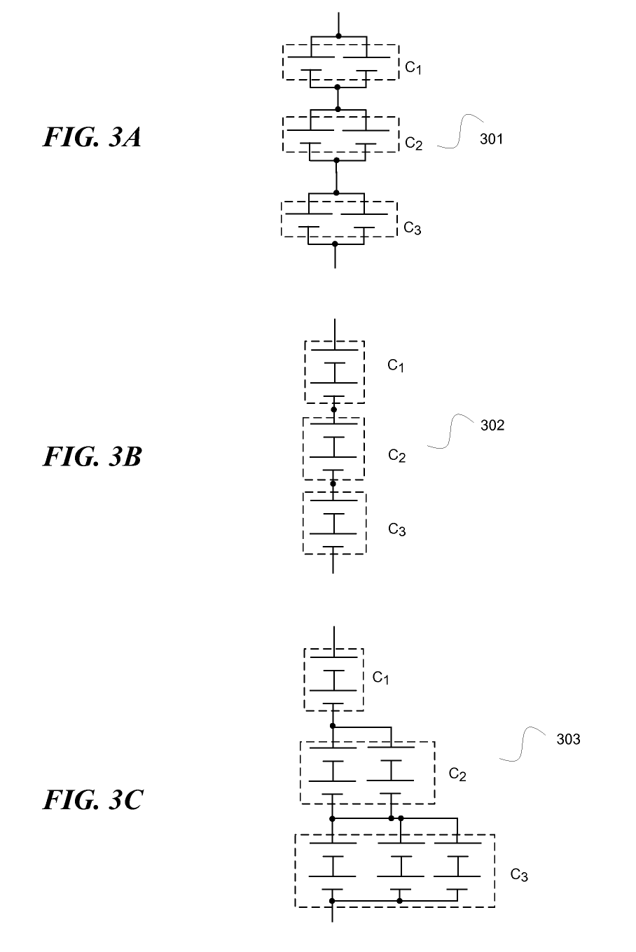

Refer to the battery balance apparatus 200 shown in FIG. 2, the battery pack 201 may be consisted of two battery cells, C₁ and C₂. The battery pack 201 also has an anode 202, a cathode 203, and a common connection terminal 104₁. The common connection terminals 104₂ and 104_{N-1} would be same common connection terminals and the controllable switches S₃ and S_{N} would be same controllable switches if the battery pack 101 is consisted of three battery cells (N is 3). The battery pack 101 also could be consisted of four or hundreds of battery cells. So, N may be any integer greater than 1, such as 2, 3, 4 or others. In an embodiment, each battery cell is consisted of one battery. In another embodiment, as the battery pack 301 shown in FIG. 3A, each battery cell is consisted of many parallel-connected batteries. For example, each battery cell may be consisted of 2, 3 or more parallel-connected batteries. In the embodiments described above, the number of the parallel-connected batteries in the battery cells may be equal, e.g. each battery cell has 2 parallel-connected batteries. The number of parallel-connected batteries may also be unequal because of design, battery breakdown, or improper connection. For example, the battery cell C₁ may be consisted of two parallel-connected batteries, the battery cell C₂ may be consisted of three or more parallel-connected batteries. The quantity difference of the parallel-connected batteries among the battery cells would lead to different internal resistance, different charge or discharge speed, and thus cause imbalance. In one embodiment, the imbalance can be eliminated by the battery balance apparatus disclosed in the present invention. In one embodiment, as the battery pack 302 shown in FIG. 3B, each of the battery cells is consisted of same number of serial-connected batteries to reduce the number of the switches. Each of the battery cells may be consisted of two, three or more batteries connected in serial. In a particular embodiment, as the battery pack 303 shown in FIG. 3C, the battery cells may comprise same or different number of parallel-connected battery branches. All of the battery branches have same number of serial-connected batteries.

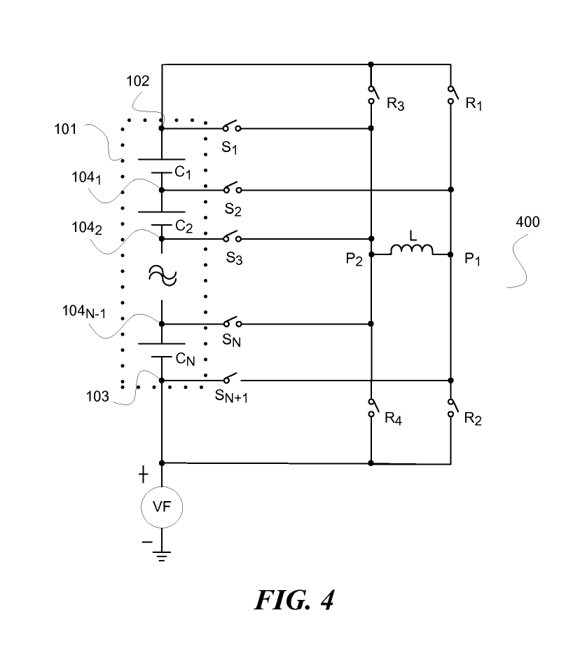

In one embodiment, the cathode 103 of the battery pack is connected to the ground. In other embodiments, such as the battery balance apparatus 400 shown in FIG. 4, the cathode 103 of the battery pack can also be coupled to a positive power supply or a negative power supply. The power supply VF shown in FIG. 4 may be provided by a battery cell, a battery pack, a switching converter, or a linear regulator.

In the following description, a battery cell of which the energy (electronic quantity) needs to be reduced is called an over voltage battery cell. Normally, the voltage or electronic quantity of an over voltage battery cell is higher than the other battery cells, which may be caused by over-charge, less discharge or bigger electric capacity. A battery cell of which the energy (electronic quantity) needs to be increased is called an under voltage battery cell. Normally, the voltage or electronic quantity of an under voltage battery cell is lower than the other battery cells, which may be caused by less-charge, over discharge or smaller electric capacity. In an embodiment, a battery cell would be regarded as an over voltage battery cell if its voltage drop is higher than a first reference. In another embodiment, a battery cell would be regarded as an under voltage battery cell if its voltage drop is lower than a second reference.

Many ways could be used to balance the battery cells, comprising transferring energy from an over voltage battery cell to the battery pack, transferring energy from the battery pack to an under voltage battery cell, and transferring energy from an over voltage battery cell to an under voltage battery cell.

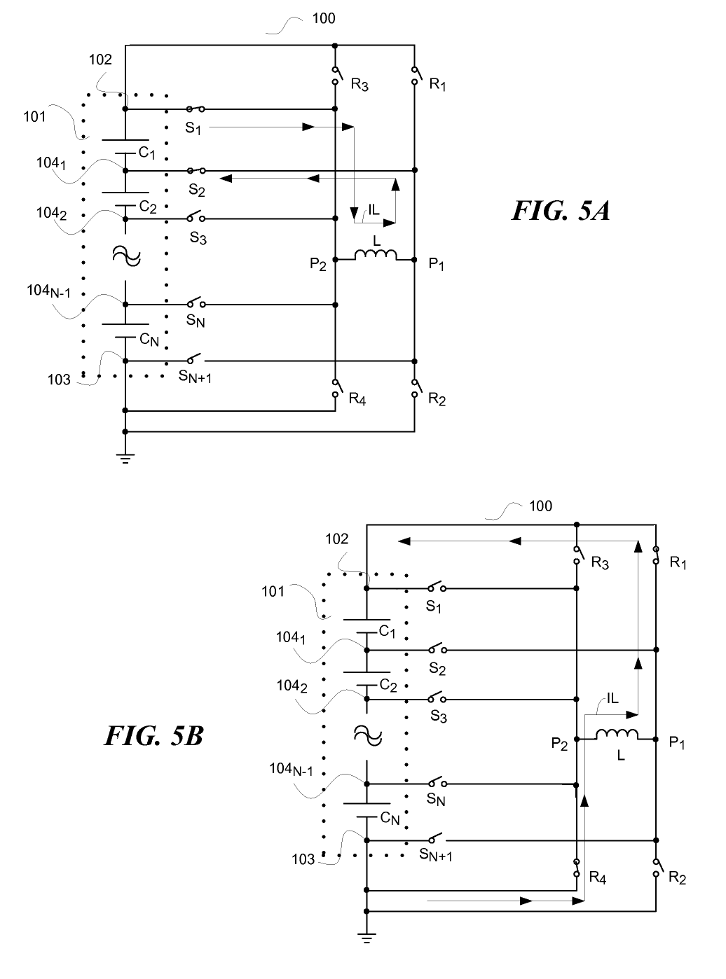

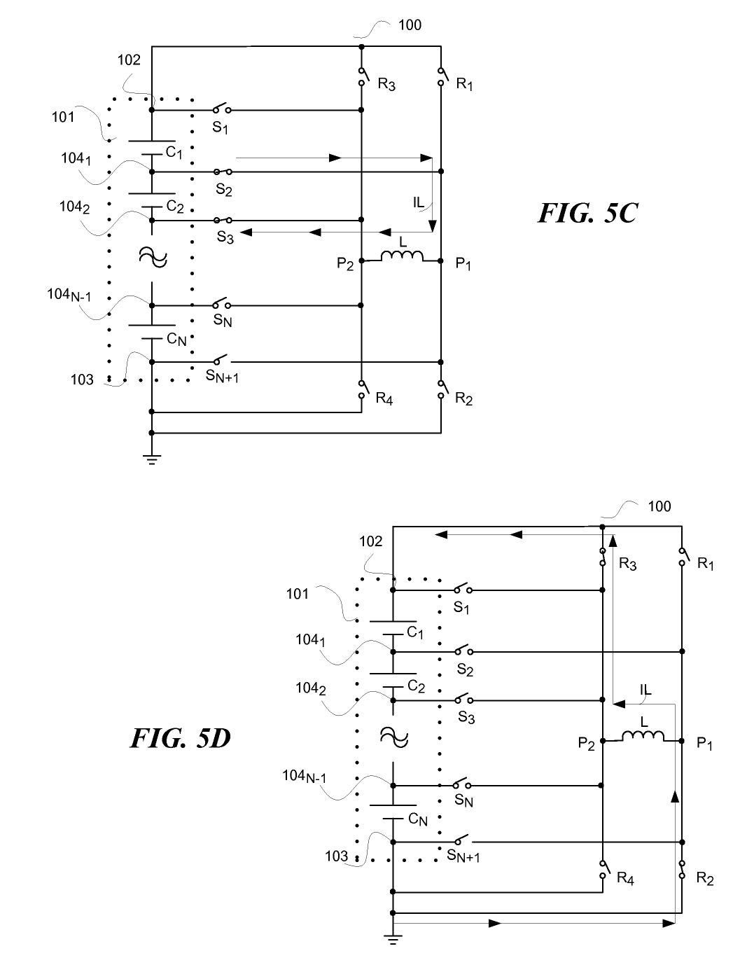

According to one embodiment of the present invention, an over voltage battery cell charges the battery pack 101 through the inductor L, so as to transfer energy to the battery pack 101. Assuming that the battery cell C₁ is an over voltage battery cell, its energy would be transferred to the battery pack 101. FIG. 5A and FIG. 5B show the operation of the apparatus 100 when energy is transferred from the battery cell C₁ to the battery pack 101. As shown in FIG. 5A, in a first period, the controllable switches S₂ and S₁ coupled to the cathode and the anode of the over voltage battery cell C₁ are kept on, the other N−1 controllable switches of the N+1 controllable switches and the first rectifying switch to the fourth rectifying switch are off, and the over voltage battery cell C₁ charges the inductor L and the inductor current IL is increased. As shown in FIG. 5B, in a second period, the controllable switches S₁ and S₂ are kept off, the rectifying switches R1 and R4 are kept on, and the rectifying switches R1 and R4 are kept off. The battery pack 101 is charged by the inductor current IL, the inductor current IL is decreased. Since the inductor current IL can not change abruptly, it should choose the path formed by the rectifying switches R₁ and R₄ to charge the battery pack 101 instead of the path formed by the rectifying switches R₂ and R₃.

The rising rate of the inductor current IL is proportional to the voltage across the battery cell C₁, the falling rate of the inductor current IL is proportional to the voltage across the battery pack 101. Normally, the falling rate is higher than the rising rate since the voltage across the battery pack 101 is higher than the voltage across the battery cell C₁. The inductor current IL is easy to become negative. In some applications, to prevent the inductor current IL from dropping to a negative value, the rectifying switches R₁ and R₄ would be turned off (disconnected) when the inductor current IL drops to zero. In some embodiments, a third time period is further comprised, wherein the rectifying switches R₁˜R₄ are kept off and the inductor current IL is kept zero. It should be noted that, due to the limitation of the accuracy, zero is an approximate value which is generally around hundreds of milliamperes.

Assuming that the battery cell C₂ is an over voltage battery cell, its energy would be transferred to the battery pack 101. FIG. 5C and FIG. 5D show the operation of the apparatus 100 when energy is transferred from the battery cell C₂ to the battery pack 101. As shown in FIG. 5C, in a first period, the controllable switches S₃ and S₂ coupled to the cathode and the anode of the over voltage battery cell C₂ are kept on, the over voltage battery cell C₂ charges the inductor L and the inductor current IL is increased. As shown in FIG. 5D, in a second period, the controllable switches S₃ and S₂ are kept off, the rectifying switches R₂ and R₃ are kept on, the rectifying switches R₁ and R₄ are kept off, the battery pack 101 is charged by the inductor current IL and the inductor current IL is decreased. Since the inductor current IL can not change abruptly, it should choose the path formed by the rectifying switches R₂ and R₃ to charge the battery pack 101 instead of the path formed by the rectifying switches R₁ and R₄.

Similarly, in some applications, to prevent the inductor current IL from dropping to a negative value, the rectifying switches R₂ and R₃ would be turned off when the inductor current IL falls to zero. So, in some embodiments, a third time period is further comprised, wherein the rectifying switches R₁˜R₄ are kept off and the inductor current IL is kept zero.

Similar methods could be used to transfer the energy from other over voltage battery cells to the battery pack 101.

It needs to be noted that names such as controllable switch and rectifying switch described herein are used for convenience of expression only. “Rectifying” and “controllable” are only used to distinguish the switches, and do not represent any physical difference. It does not mean that a switch should have certain features or should not have certain features. It also does not mean that a switch is with external control or without external control. For example, a rectifying switch can not be regarded as a switch that must have or only have rectifying function. In some embodiments, a rectifying switch is also controlled by some external signals. A controllable switch can not be regarded as a switch that must be controlled by an external signal. Some self-controlled devices or rectifying devices (such as diodes) could also be used as the controllable switches.

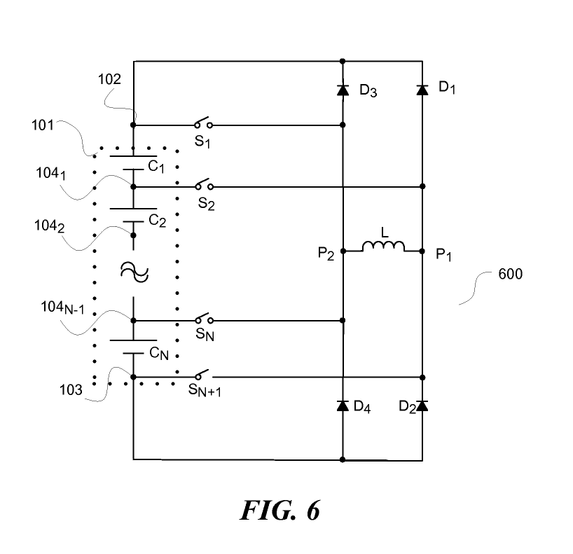

FIG. 6 shows a battery balance apparatus 600 in accordance with an embodiment of the present invention, wherein the rectifying switches R₁˜R₄ are respectively consisted of diodes D₁˜D₄. The cathodes of the diodes D₁ and D₃ are coupled to the anode 102 of the battery pack 101, the anodes of the diodes D₂ and D₄ are coupled to the cathode 103 of the battery pack 101. Since diodes are used as the rectifying switches, as shown in FIG. 5B, in the second period, the inductor current IL would automatically select the path formed by the diodes D₁ and D₄ after the rectifying switches S₂ and S₁ are turned off. The diodes D₁ and D₄ will be automatically turned off if the inductor current IL drops to zero.

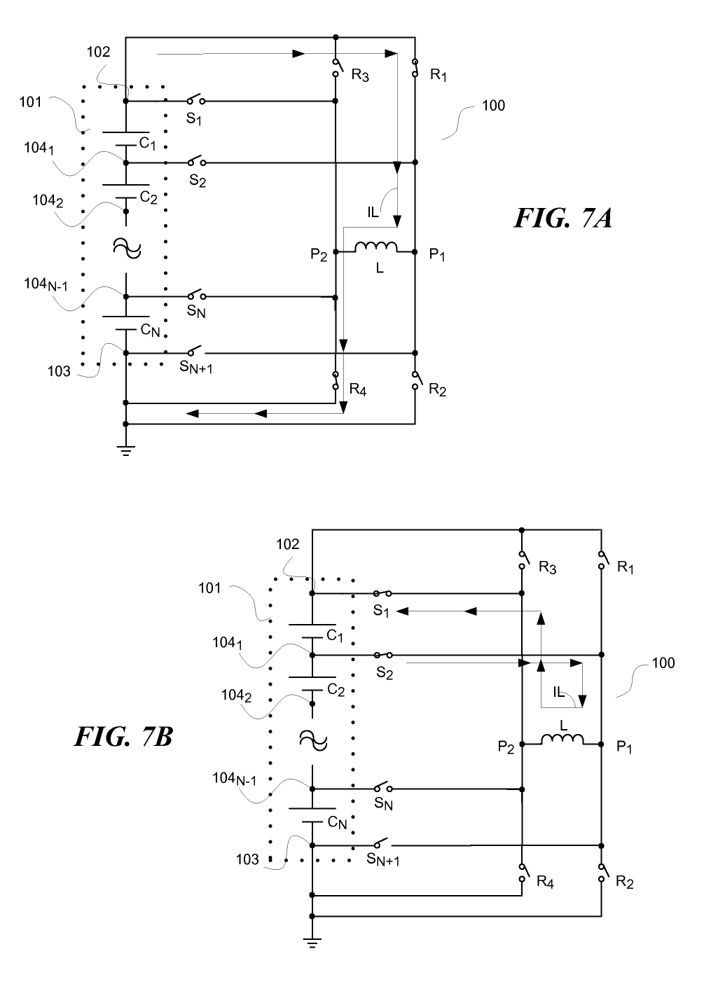

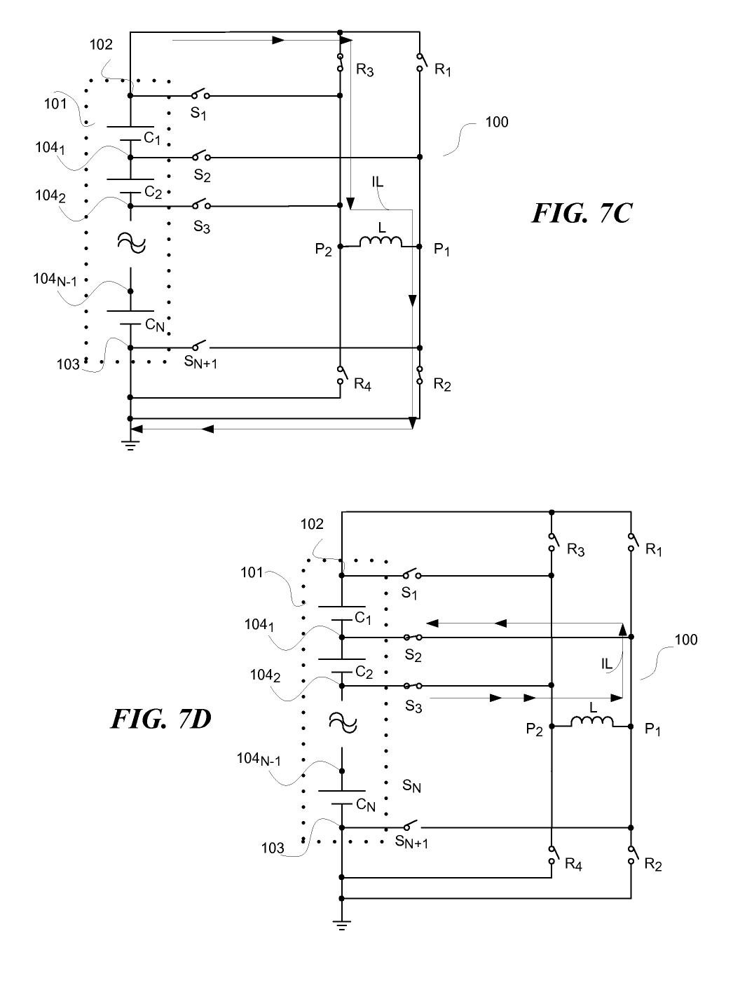

According to one embodiment of the present invention, the battery pack 101 charges an under voltage battery cell through the inductor L, so as to transfer energy to the under voltage battery cell. Assuming that the battery cell C₁ is an under voltage battery cell, the energy of the battery pack 101 would be transferred to the under voltage battery cell C₁. FIG. 7A and FIG. 7B show the operation of the apparatus 100 when the energy is transferred from the battery pack 101 to the battery cell C₁. As shown in FIG. 7A, in a first period, the rectifying switches R₁ and R₄ are kept on and the rectifying switches R₂ and R₃ are kept off, the inductor L is charged by the battery pack 101 and the inductor current IL is increased. As shown in FIG. 7B, in a second period, the rectifying switches R₁ and R₄ are kept off, the controllable switches S₂ and S₁ coupled to the cathode and the anode of the under voltage battery cell C₁ are kept on. The under voltage battery cell C₁ is charged by the inductor current IL, the inductor current IL is decreased. Since the inductor current IL can not change abruptly, it should choose the path formed by the rectifying switches R₁ and R₄ to charge the inductor L instead of the path formed by the rectifying switches R₂ and R₃.

In some applications, to prevent the inductor current IL from dropping to a negative value, the controllable switches S₂ and S₁ would be turned off (disconnected) when the inductor current IL drops to zero. In some embodiments, a third time period is further comprised, wherein the rectifying switches R₁˜R₄ are kept off and the inductor current IL is kept zero.

Assuming that the battery cell C₂ is an under voltage battery cell, the energy of the battery pack 101 would be transferred to the battery cell C₂. FIG. 7C and FIG. 7D show the operation of the apparatus 100 when energy is transferred from the battery pack 101 to the battery cell C₂. As shown in FIG. 7C, in a first period, the rectifying switches R₂ and R₃ are kept on and the rectifying switches R₁ and R₄ are kept off, the battery pack 101 charges the inductor L and the inductor current IL is increased. As shown in FIG. 7D, in a second period, the rectifying switches R2 and R3 are kept off, the controllable switches S₃ and S₂ coupled to the cathode and the anode of the over voltage battery cell C₂ are kept on. The under voltage battery cell C₂ is charged by the inductor current IL, the inductor current IL is decreased. Since the inductor current IL can not change abruptly, it should choose the path formed by the rectifying switches R₂ and R₃ to charge the inductor L instead of the path formed by the rectifying switches R₁ and R₄.

Similarly, in some applications, to prevent the inductor current IL from dropping to a negative value, the controllable switches S₂ and S₃ would be turned off when the inductor current IL falls to zero. In some embodiments, a third time period is further comprised, wherein the rectifying switches R₁˜R₄ are kept off and the inductor current IL is kept zero.

Similar methods could be used to transfer the energy from the battery pack 101 to other under voltage battery cells.

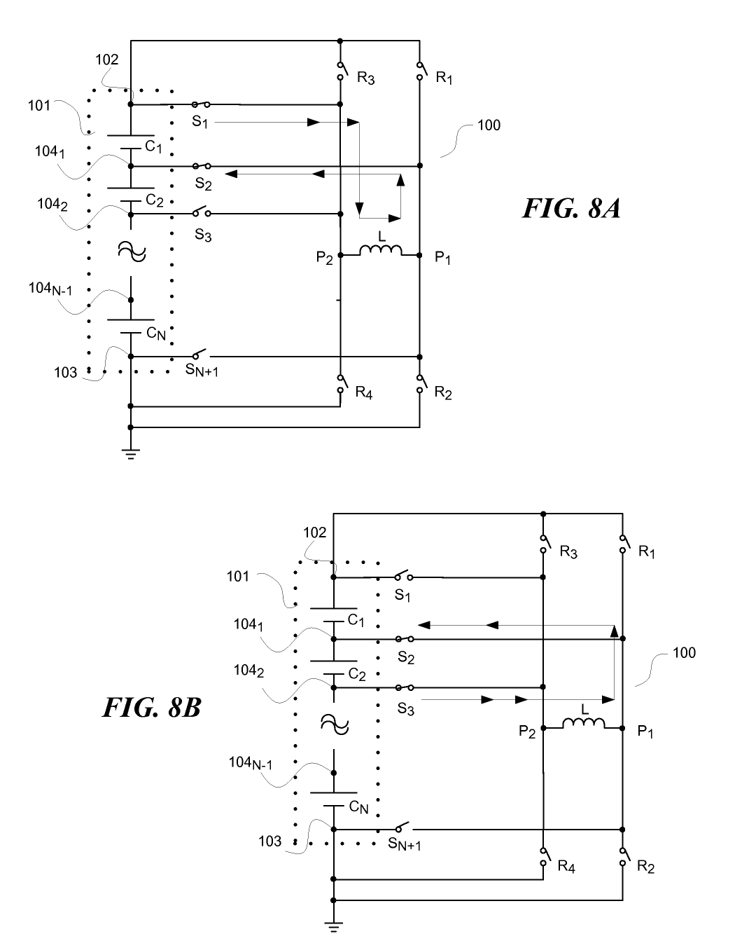

In some embodiments, the battery pack 101 may contain some over voltage battery cells and some under voltage battery cells at the same time. According to one embodiment of the present invention, an over voltage battery cell charges an under voltage battery cell through the inductor L, so as to transfer energy to the under voltage battery cell. Assuming that the battery cell C₁ is an over voltage battery cell and the battery cell C₂ is an under voltage battery cell, the energy of the battery cell C₁ would be transferred to the battery cell C₂. FIG. 8A and FIG. 8B show the operation of the apparatus 100 when energy is transferred from the battery cell C₁ to the battery cell C₂. As shown in FIG. 8A, in a first period, the controllable switches S₂ and S₁ coupled to the cathode and the anode of the over voltage battery cell C₁ are kept on, the battery cell C₁ charges the inductor L and the inductor current IL is increased. As shown in FIG. 8B, in a second period, the controllable switches S₁ is kept off, the controllable switches S₃ and S₂ coupled to the cathode and the anode of the under voltage battery cell C₂ are kept on. The under voltage battery cell C₂ is charged by the inductor current IL, the inductor current IL is decreased.

According to one embodiment of the present invention, the battery systems 100 further comprises a selection circuit, configured to select an over voltage cell and an under voltage battery cell of which the energy could be transferred mutually. The selected over voltage and under voltage battery cells need to have the below features. The controllable switch coupled to the anode of the over voltage cell and the controllable switch coupled to the cathode of the under voltage cell are coupled to same terminal of the inductor L, such as the second terminal P₂. The controllable switch coupled to the cathode of the over voltage cell and the controllable switch coupled to the anode of the under voltage cell are coupled to the other terminal of the inductor L, such as the first terminal P₁. In the embodiments shown in FIG. 8A and FIG. 8B, the controllable switch S₁ coupled to the anode of the over voltage cell C₁ and the controllable switch S₃ coupled to the cathode of the under voltage cell C₂ are coupled to the second terminal P₂ of the inductor L, the controllable switch S₂ coupled to the cathode of the over voltage cell C₁ and the anode of the under voltage cell C₂ is coupled to the first terminal P₁ of the inductor L.

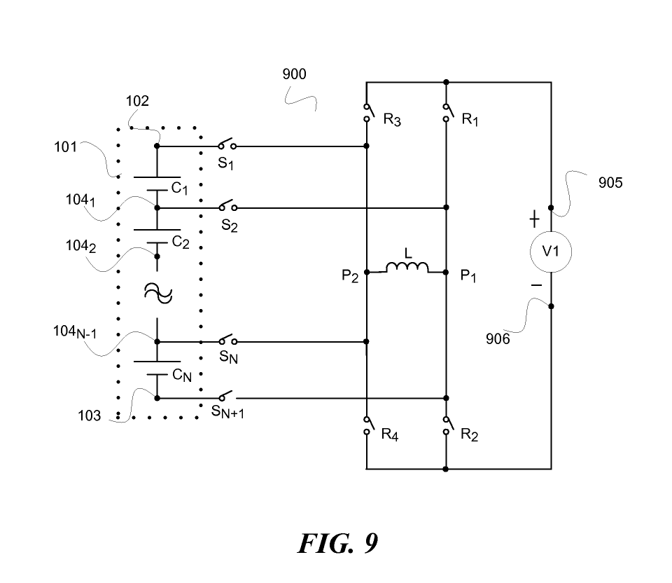

FIG. 9 schematically shows a battery balance apparatus 900 according to an embodiment of the present invention. The battery balance apparatus 900 is coupled to a power supply V1 having an anode and cathode. The battery balance apparatus 900 comprises a battery pack 101, rectifying switches R₁˜R₄, an inductor L and controllable switches S₁˜S_{N+1}. The battery pack 101 comprises serial-connected battery cells C₁˜C_{N}. The battery pack 101 has an anode 102, a cathode 103, and a plurality of common connection terminals 104₁˜104_{N-1} formed by the adjacent battery cells. The inductor L has two terminals, a first terminal P₁ and a second terminal P₂. The first rectifying switch R₁ is coupled between the anode 905 of the power supply V1 and the first terminal P₁ of the inductor L. The second rectifying switch R₂ is coupled between the cathode 906 of the power supply V1 and the first terminal P₁ of the inductor L. The third rectifying switch R₃ is coupled between the anode 905 of the power supply V1 and the second terminal P₂ of the inductor L. The fourth rectifying switch R₄ is coupled between the cathode 906 of the power supply V1 and the second terminal P₂ of the inductor L. The controllable switches S₁˜S_{N+1} are configured to respectively couple the anode and the cathode of each of the battery cells to the two terminals of the inductor L. The controllable switch S₁ is coupled to the anode 102 of the battery pack 101. The controllable switches S₂˜S_{N} are coupled to the common connection terminals 104₁˜104_{N-1} of the battery pack 101. The controllable switch S_{N+1} is coupled to the cathode 103 of the battery pack 101.

The power supply V1 shown in FIG. 9 may be provided by a battery cell, a battery pack, a switching converter, or a linear regulator. In an embodiment, the power supply V1 and part of the battery balance apparatus 900 could be fabricated on same wafer.

In one embodiment, the power supply V1 charges the battery pack 101 firstly and charges the under voltage cells secondly.

The battery pack 101 and the battery cells could be directly charged by the power supply V1 regardless of the inductor L. For example, the battery pack 101 is directly charged by the power supply V1 when the controllable switches S₁ and S_{N+1}, the rectifying switches R₂ and R₃ are kept on. The battery cell C₁ is directly charged by the power supply V1 when the controllable switches S₁ and S₂, the rectifying switches R₂ and R₃ are kept on. In one embodiment, the voltage source V1 has a current limit function. In another embodiment, to protect the battery cells or the battery pack 101 from being damaged during direct charge, a current limit circuit is coupled between the apparatus 900 and the voltage source V1.

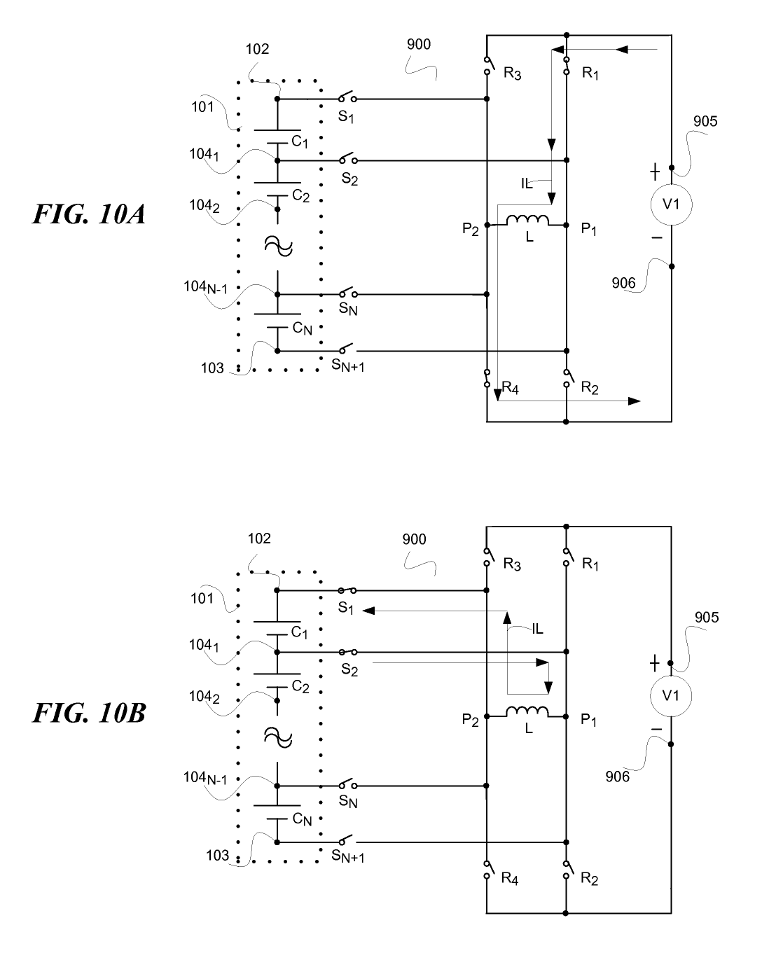

The voltage source V1 can charge battery cells through the inductor L. Assuming that the battery cell C₁ is an under voltage battery cell, the energy of the voltage source V1 would be transferred to the battery cell C₁. FIG. 10A and FIG. 10B show the operation of the apparatus 900 when energy is transferred from the voltage source V1 to the battery cell C₁. As shown in FIG. 10A, in a first period, the rectifying switches R₁ and R₄ are kept on and the rectifying switches R₂ and R₃ are kept off, the voltage source V1 charges the inductor L and the inductor current IL is increased. As shown in FIG. 10B, in a second period, the rectifying switches R₁˜R₄ are kept off, the controllable switches S₂ and S₁ coupled to the cathode and the anode of the under voltage battery cell C₁ are kept on. The under voltage battery cell C₁ is charged by the inductor current IL and the inductor current IL is decreased. Since the inductor current IL can not change abruptly, it should choose the path formed by the rectifying switches R₁ and R₄ to charge the battery pack 101 instead of the path formed by the rectifying switches R₂ and R₃.

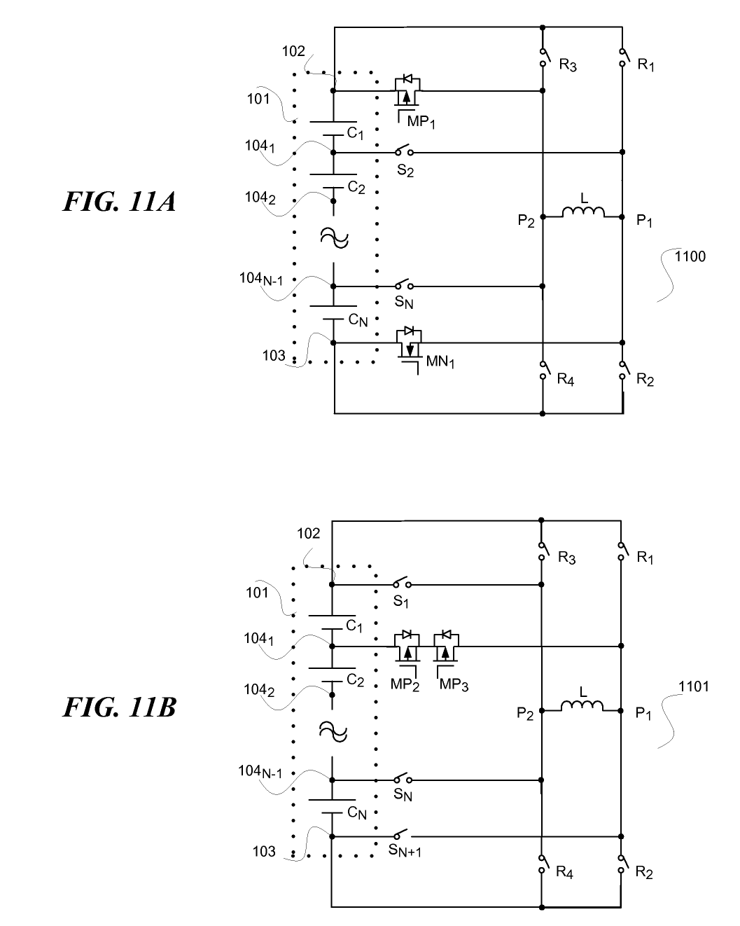

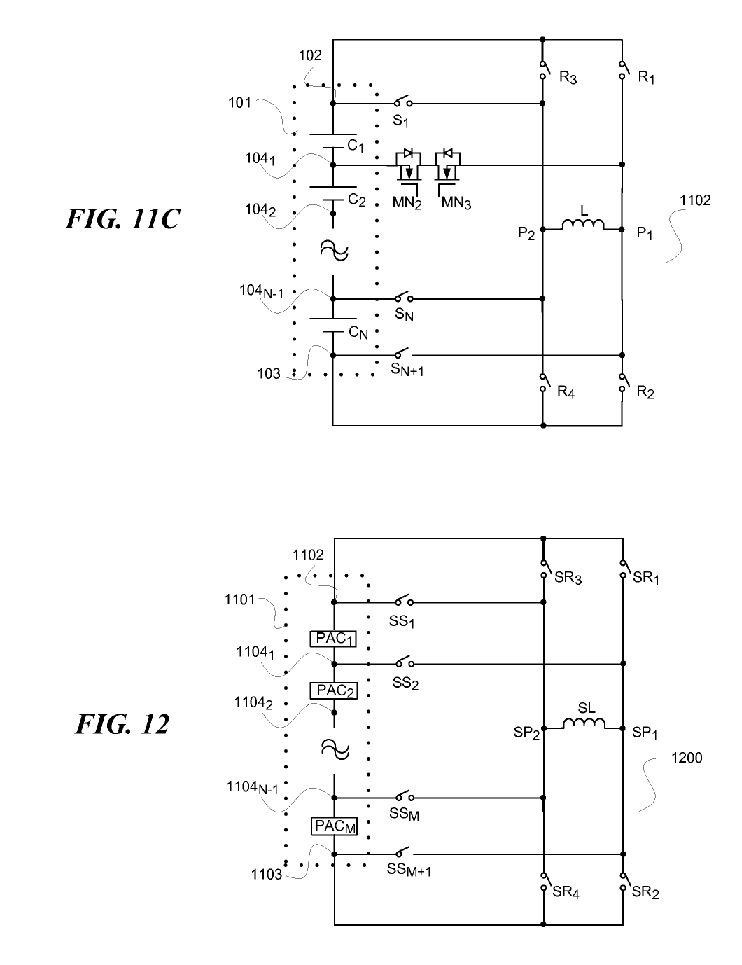

Typically, MOS (metal oxide semiconductor) devices are the best choice to fabricate switches. MOS devices can be divided into P-type MOS (PMOS) devices and N-type MOS (NMOS) devices. Both NMOS and PMOS could be used as the rectifying switches and the controllable switches. In one embodiment, as shown in FIG. 11A, the controllable switch S₁ is a PMOS device MP1, the controllable switch S_{N+1} is a NMOS device MN1.

In one embodiment, as shown in FIG. 11B, at least one controllable switch comprises two serial-connected PMOS devices MP2 and MP3. The substrates of the serial-connected PMOS devices are coupled to the common connection terminal of MP2 and MP3. In other embodiments, the controllable switches S₂˜S_{N} also could comprise serial-connected PMOS devices.

In one embodiment, as shown in FIG. 11C, at least one controllable switch comprises two serial-connected NMOS devices MN2 and MN3. The substrates of the serial-connected NMOS devices are coupled to the terminals opposite to the common connection terminal of the two serial-connected NMOS devices. In other embodiments, the controllable switches S₂˜S_{N} also could comprise serial-connected NMOS devices.

The voltage across the inductor L would be changed during charge and discharge of the battery cells or the battery pack 101, which would induce a variable voltage at the terminals of the controllable switches S₂˜S_{N} that are connected to the inductor L. For example, the voltage at the first terminal P₁ of the inductor L may be higher than the voltage at the second terminal P₂ in a first period, and would be lower than the voltage at the second terminal P₂ in a second period. To prevent the substrate leakage, the substrate of PMOS devices should be coupled to a relatively higher potential and the substrate of NMOS devices should be coupled to a relatively lower potential. For the serial-connected PMOS devices shown in FIG. 11B and the serial-connected NMOS devices shown in FIG. 11C, the substrate of at least one of the two serial-connected MOS devices is shut off. So, the substrate leakage current of the devices are zero, and there is no need to use any substrate selection circuit to set the potential of the substrates.

The serial-connected PMOS or serial-connected NMOS devices shown in FIGS. 11B-11C could also be used to fabricate the controllable switches S₁˜S_{N+1} of the apparatus 900.

In some applications, a huge battery pack comprising hundreds of battery cells may be needed. It would be low efficient if the battery cells are balanced one by one. One solution is to divide these hundreds of battery cells (called a stack battery pack) into several battery packs. That is, a stack battery pack is consisted of several battery packs wherein each of the battery packs comprises a plurality of battery cells. A stack balance apparatus could be used to balance the battery packs, comprising transferring energy between the stack battery pack and a battery pack, or transferring energy between the battery packs. A battery balance apparatus could be used to balance the battery cells, comprising transferring energy between a battery pack and a battery cell, or transfer energy between the battery cells.

FIG. 12 shows a stack balance apparatus 1200 in accordance with an embodiment of the present invention. The stack balance apparatus 1200 comprises a balance apparatus pack 1101, rectifying stack switches SR₁˜SR₄, a stack inductor SL and controllable stack switches SS₁˜SS_{M+1}. The balance apparatus pack 1101 comprises serial-connected battery balance apparatuses PAC₁˜PAC_{M}. The balance apparatus pack 1101 has an anode 1102, a cathode 1103, and a plurality of common connection terminals 1104₁˜1104_{N-1} formed by the adjacent battery balance apparatuses. The stack inductor SL has two terminals, a first terminal SP₁ and a second terminal SP₂.

The first rectifying stack switch SR₁ is coupled between the anode 1102 of the balance apparatus pack 1101 and the first terminal SP₁ of the stack inductor SL. The second rectifying stack switch SR₂ is coupled between the cathode 1103 of the balance apparatus pack 1101 and the first terminal SP₁ of the stack inductor SL. The third rectifying stack switch SR₃ is coupled between the anode 1102 of the balance apparatus pack 1101 and the second terminal SP₂ of the stack inductor SL. The fourth rectifying stack switch SR₄ is coupled between the cathode 1103 of the balance apparatus pack 1101 and the second terminal SP₂ of the stack inductor SL. The controllable stack switches SS₁˜SS_{M+1} are configured to respectively couple the anode and the cathode of each of the battery balance apparatuses to the two terminals the stack inductor SL. The controllable stack switch SS₁ is coupled to the anode 1102 of the balance apparatus pack 1101. The controllable stack switches SS₂˜SS_{M} are coupled to the common connection terminals 1104₁˜1104_{N-1} of the balance apparatus pack 1101. The controllable stack switch SS_{M+1} is coupled to the cathode 1103 of the balance apparatus pack 1101.

Compared to the battery balance apparatus 100 shown in FIG. 1, the difference between the stack balance apparatus 1200 and the battery balance apparatus 100 is the replacement of the battery pack 101 by the balance apparatus pack 1101. Therefore, the aforementioned various working principles, modifications and variations of the battery balance apparatus 100 can also be applied to the stack balance apparatus 1200.

Each of the battery balance apparatuses comprises a battery pack. In the following description, a battery pack of which the energy (electronic quantity) needs to be reduced is called an over voltage battery pack and the corresponding battery balance apparatus would be called an over voltage battery balance apparatus. A battery pack of which the energy (electronic quantity) needs to be increased is called an under voltage battery pack and the corresponding balance apparatus would be called an under voltage battery balance apparatus.

Many ways could be used to balance the battery packs, comprising transferring energy from an over voltage battery pack to the balance apparatus pack 1101 (or the stack battery pack), transferring energy from the balance apparatus pack 1101 (or the stack battery pack) to an under voltage battery pack, and transferring energy from an over voltage battery pack to an under voltage battery pack.

The battery balance apparatus PAC₁˜PAC_{M} could be implemented by prior arts, or technologies shown in the BACKGROUND. In one embodiment, the embodiments shown in FIG. 1˜FIG. 11C could be used to as one or more of the battery balance apparatuses PAC_{T}˜PAC_{M}.

Each of the battery balance apparatuses could balance its internal battery cells independently. The battery balance apparatuses could balance the battery cells simultaneously or un-simultaneously. For example, the battery balance apparatus PAC₂ could balance its battery cells when the battery balance apparatus PAC₁ is balancing its battery cells.

To balance all of the battery cells, it could use battery balance apparatuses to respectively balance the battery cells in the battery packs firstly and use the stack balance apparatus 1200 to balance the battery packs secondly. It also could use the stack balance apparatus 1200 to balance the battery packs firstly and use battery balance apparatuses to respectively balance the battery cells in the battery packs secondly. In a particular embodiment, a balance operation comprises: during a first period, the battery cells in the battery pack are respectively balanced by the corresponding battery balance apparatuses; during a second period, the battery packs are balanced by the stack balance apparatus; and during a third period, the battery cells in the battery packs are respectively balanced by the corresponding battery balance apparatuses again.

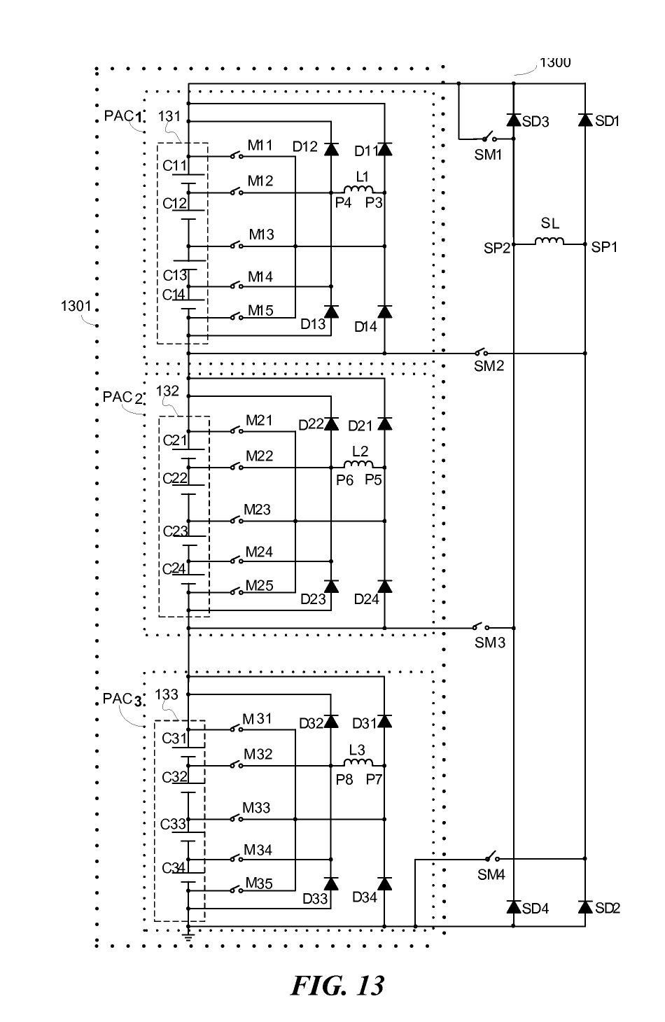

FIG. 13 shows a stack balance apparatus 1300 in accordance with an embodiment of the present invention. The stack balance apparatus 1300 comprises a balance apparatus pack 1301, stack diodes SD₁˜SD₄, a stack inductor SL and controllable stack switches SM₁ to SM₄. The balance apparatus pack 1301 comprises serial-connected battery balance apparatuses PAC₁ to PAC_{S}. The stack inductor SL has two terminals, a first terminal SP₁ and a second terminal SP₂. The first stack diode SD₁ is coupled between the anode of the balance apparatus pack 1301 and the first terminal SP₁ of the stack inductor SL. The second stack diode SD₂ is coupled between the cathode of the balance apparatus pack 1301 and the first terminal SP₁ of the stack inductor SL. The third stack diode SD₃ is coupled between the anode of the balance apparatus pack 1301 and the second terminal SP₂ of the stack inductor SL. The fourth stack diode SD₄ is coupled between the cathode of the balance apparatus pack 1301 and the second terminal P₂ of the stack inductor L. The controllable stack switches SM₁˜SM₄ are configured to respectively couple the anode and the cathode of each of the battery balance apparatuses to the two terminals of the stack inductor SL.

The battery balance apparatus PAC₁ comprises a battery pack 131, rectifying diodes D₁₁˜D₁₄, an inductor L1 and controllable switches M₁₁˜M₁₅. The battery pack 131 comprises serial-connected battery cells C₁₁˜C₁₄. The inductor L₁ has two terminals, a first terminal P₃ and a second terminal P₄. The first rectifying diode D₁₁ is coupled between the anode of the battery pack 131 and the first terminal P₃ of the inductor L₁. The second rectifying diode D₁₂ is coupled between the cathode of the battery pack 131 and the first terminal P₃ of the inductor L₁. The third rectifying diode D₁₃ is coupled between the anode of the battery pack 131 and the second terminal P₄ of the inductor L₁. The fourth rectifying diode D₁₄ is coupled between the cathode of the battery pack 131 and the second terminal P₄ of the inductor L₁. The controllable switches M₁₁˜M₁₅ are configured to respectively couple the anode and the cathode of each of the battery cells to the two terminals of the inductor L₁.

The battery balance apparatuses PAC₂ and PAC₃ have substantially the same structure with PAC₁.

Battery balance apparatuses have been disclosed. While specific embodiments of the present invention have been provided, it is to be understood that these embodiments are for illustration purposes and not limiting. Many additional embodiments will be apparent to persons of ordinary skill in the art reading this invention.

I/We claim:

1. A battery balance apparatus, comprising:
a battery pack having an anode and a cathode, wherein the battery pack comprise N serial-connected battery cells, N is an integer larger than one, and wherein each of the battery cells has an anode and a cathode, and wherein the anode of the battery pack is coupled to the anode of the first serial-connected battery cell, and the cathode of the battery pack is coupled to the cathode of the Nth serial-connected battery cell;
an inductor having a first terminal and a second terminal;
a first rectifying switch coupled between the anode of the battery pack and the first terminal of the inductor;
a second rectifying switch coupled between the cathode of the battery pack and the first terminal of the inductor;
a third rectifying switch coupled between the anode of the battery pack and the second terminal of the inductor;
a fourth rectifying switch coupled between the cathode of the battery pack and the second terminal of the inductor; and
N+1 controllable switches, wherein the first controlled switch is coupled between the anode of the first battery cell and the second terminal of the inductor, the second controlled switch is coupled between the anode of the second battery cell and the first terminal of the inductor, and the third controlled switch is coupled between the cathode of the second battery cell and the second terminal of the inductor.

2. The battery balance apparatus of claim 1, wherein energy is transferred from an over voltage battery cell to the battery pack through the inductor.

3. The battery balance apparatus of claim 2, wherein:
during a first period, the controllable switches coupled to the cathode and the anode of the over voltage battery cell are on, the other N−1 controllable switches of the N+1 controllable switches and the first rectifying switch to the fourth rectifying switch are off, and the inductor is charged by the over voltage battery cell; and
during a second period, the N+1 controllable switches, the second rectifying switch and the third rectifying switch are off, and the battery pack is charged by the inductor through the first rectifying switch and the fourth rectifying switch.

4. The battery balance apparatus of claim 2, wherein:
during a first period, the controllable switches coupled to the cathode and the anode of the over voltage battery cell are on, the other N−1 controllable switches of the N+1 controllable switches and the first rectifying switch to the fourth rectifying switch are off, and the inductor is charged by the over voltage battery cell; and
during a second period, the N+1 controllable switches, the first rectifying switch and the fourth rectifying switch are off, and the battery pack is charged by the inductor through the second rectifying switch and the third rectifying switch.

5. The battery balance apparatus of claim 2, wherein the first, second, third and fourth rectifying switches are diodes.

6. The battery balance apparatus of claim 1, wherein energy is transferred from the battery pack to an under voltage battery cell through the inductor.

7. The battery balance apparatus of claim 6, wherein:
during a first period, the N+1 controllable switches, the second rectifying switch and the third rectifying switch are off, and the inductor is charged by the battery pack through the first rectifying switch and the fourth rectifying switch; and
during a second period, the controllable switches coupled to the cathode and the anode of the under voltage battery cell are on, the other N−1 controllable switches of the N+1 controllable switches and the first rectifying switch to the fourth rectifying switch are off, and the under voltage battery cell is charged by the inductor.

8. The battery balance apparatus of claim 6, wherein:
during a first period, the N+1 controllable switches, the first rectifying switch and the fourth rectifying switch are off, and the inductor is charged by the battery pack through the second rectifying switch and the third rectifying switch; and
during a second period, the controllable switches coupled to the cathode and the anode of the under voltage battery cell are on, the other N−1 controllable switches of the N+1 controllable switches and the first rectifying switch to the fourth rectifying switch are off, and the under voltage battery cell is charged by the inductor.

9. The battery balance apparatus of claim 1, wherein energy is transferred from an over voltage battery cell to an under voltage battery cell through the inductor.

10. The battery balance apparatus of claim 9, wherein:
during a first period, the controllable switches coupled to the cathode and the anode of the over voltage battery cell are kept on, the other N−1 controllable switches of the N+1 controllable switches and the first rectifying switch to the fourth rectifying switch are off, and the inductor is charged by the over voltage battery cell; and
during a second period, the controllable switches coupled to the cathode and the anode of the under voltage battery cell are kept on, the other N−1 controllable switches of the N+1 controllable switches and the first rectifying switch to the fourth rectifying switch are off, the under voltage battery cell is charged by the inductor.

11. A battery balance apparatus, comprising:
a battery pack having an anode and a cathode, wherein the battery pack comprise N serial-connected battery cells, and each of the battery cells has an anode and a cathode, and wherein the anode of the battery pack is coupled to the anode of the first serial-connected battery cell, and the cathode of the battery pack is coupled to the cathode of the Nth serial-connected battery cell;
an inductor having a first terminal and a second terminal;
a first rectifying switch coupled between the anode of a power supply and the first terminal of the inductor;
a second rectifying switch coupled between the cathode of the power supply and the first terminal of the inductor;
a third rectifying switch coupled between the anode of the power supply and the second terminal of the inductor;
a fourth rectifying switch coupled between the cathode of the power supply and the second terminal of the inductor; and
N+1 controllable switches wherein the first controlled switch is coupled between the anode of the first battery cell and the second terminal of the inductor, the second controlled switch is coupled between the anode of the second battery cell and the first terminal of the inductor, and the third controlled switch is coupled between the cathode of the second battery cell and the second terminal of the inductor.

12. The battery balance apparatus of claim 11, wherein energy is transferred from the power supply to an under voltage battery cell through the inductor.

13. The battery balance apparatus of claim 12, wherein:
during a first period, the N+1 controllable switches, the second rectifying switch and the third rectifying switch are off, and the inductor is charged by the power supply through the first rectifying switch and the fourth rectifying switch; and
during a second period, the controllable switches coupled to the cathode and the anode of the under voltage battery cell are on, the other N−1 controllable switches of the N+1 controllable switches and the first rectifying switch to the fourth rectifying switch are off, and the under voltage battery cell is charged by the inductor.

14. The battery balance apparatus of claim 12, wherein:
during a first period, the N+1 controllable switches, the first rectifying switch and the fourth rectifying switch are off, and the inductor is charged by the battery pack through the second rectifying switch and the third rectifying switch; and
during a second period, the controllable switches coupled to the cathode and the anode of the under voltage battery cell are on, the other N−1 controllable switches of the N+1 controllable switches and the first rectifying switch to the fourth rectifying switch are off, and the under voltage battery cell is charged by the inductor.

15. The battery balance apparatus of claim 11, wherein at least one of the controllable switches comprises two serial-connected PMOS or two serial-connected NMOS.

16. A stack balance apparatus, comprising:
a balance apparatus pack having an anode and a cathode, wherein the balance apparatus pack comprise M serial-connected battery balance apparatuses, M is an integer larger than one, and wherein each of the battery balance apparatuses has an anode and a cathode, and wherein the anode of the stack battery pack is coupled to the anode of the first serial-connected balance apparatuses, and the cathode of the battery pack is coupled to the cathode of the Nth serial-connected balance apparatuses;
a stack inductor having a first terminal and a second terminal;
a first rectifying stack switch coupled between the anode of the balance apparatus pack and the first terminal of the stack inductor;
a second rectifying stack switch coupled between the cathode of the balance apparatus pack and the first terminal of the stack inductor;
a third rectifying stack switch coupled between the anode of the balance apparatus pack and the second terminal of the stack inductor;
a fourth rectifying stack switch coupled between the cathode of the balance apparatus pack and the second terminal of the stack inductor; and
M+1 controllable stack switches wherein the first controlled switch is coupled between the anode of the first balance apparatuses and the second terminal of the stack inductor, the second controlled switch is coupled between the anode of the second balance apparatuses and the first terminal of the stack inductor, and the third controlled switch is coupled between the cathode of the second balance apparatuses and the second terminal of the stack inductor.

17. The stack balance apparatus of claim 16, wherein at least one of the battery balance apparatuses comprises:
a battery pack having an anode and a cathode, wherein the battery pack comprise N serial-connected battery cells, N is an integer larger than one, and wherein each of the battery cells has an anode and a cathode, and wherein the anode of the battery pack is coupled to the anode of the first serial-connected battery cell, and the cathode of the battery pack is coupled to the cathode of the Nth serial-connected battery cell;
an inductor having a first terminal and a second terminal;
a first rectifying switch coupled between the anode of the battery pack and the first terminal of the inductor;
a second rectifying switch coupled between the cathode of the battery pack and the first terminal of the inductor;
a third rectifying switch coupled between the anode of the battery pack and the second terminal of the inductor;
a fourth rectifying switch coupled between the cathode of the battery pack and the second terminal of the inductor; and
N+1 controllable switches wherein the first controlled switch is coupled between the anode of the first battery cell and the second terminal of the inductor, the second controlled switch is coupled between the anode of the second battery cell and the first terminal of the inductor, and the third controlled switch is coupled between the cathode of the second battery cell and the second terminal of the inductor.

18. The stack balance apparatus of claim 17, wherein:
during a first period, the battery cells in the battery packs are respectively balanced by the corresponding battery balance apparatuses;
during a second period, the battery packs are balanced by the stack balance apparatus; and
during a third period, the battery cells in the battery packs are respectively balanced by the corresponding battery balance apparatuses.

19. The stack balance apparatus of claim 16, wherein energy is transferred from an over voltage battery pack to the stack battery pack or an under voltage battery pack.

20. The stack balance apparatus of claim 16, wherein energy is transferred from the stack battery pack to an under voltage battery pack.
